(19) United States
(12) Patent Application Publication
(10) Pub. No.: US 2009/0273853 A1
(43) Pub. Date: Nov. 5, 2009

(54) Film for Improving Contrast and Preventing Moire Pattern, PDP Filter and Display Device Comprising the Same

(76) Inventors: Sang Hyun Park, Yuseong-gu, Daejeon (KR); Yeon-Keun Lee, Daejeon (KR); Jung-Doo Kim, Daejeon (KR)

Correspondence Address: MCKENNA LONG & ALDRIDGE LLP, 1900 K STREET, NW, WASHINGTON, DC, 20006, US

(21) Appl. No.: 12/226,067

(22) PCT Filed: Aug. 29, 2007
(86) PCT No.: PCT/KR2007/004144

§ 371 Date: Oct. 7, 2008

(30) Foreign Application Priority Data
Aug. 31, 2006 (KR) 10-2006-0083551

(51) Int. Cl. G02B 5/00

(52) U.S. Cl. 359/893

(57) ABSTRACT

The present invention relates to a film for improving contrast, a plasma display panel (PDP) filter including the film, and a PDP apparatus, and more particularly, to a film for improving contrast, the film capable of reducing a decrease of the contrast by shielding light from an external light source and of preventing an occurrence of moire when attached to a display apparatus, and a PDP apparatus including the film. The film included in the filter for improving contrast includes a pattern of a plurality of stripes with a section in the shape of one of being narrowed from a surface to an inner portion of the film such as a trapezoid and triangle and having a uniform width such as a rectangle and a parallelogram, wherein an angle formed by the stripe pattern and a horizontal line is 0 to 5° when staring at the film in front. According to an aspect of the present invention, there are provided a film capable of improving contrast ratio of a screen without decreasing a brightness of light emitted from a PDP, a PDP filter including the film, and a display apparatus. The provided PDP filter and the display apparatus provide a screen having a high quality preventing moire.

### TECHNICAL FIELD

The present invention relates to a film for improving contrast, a plasma display panel (PDP) filter including the film, and a PDP apparatus, and more particularly, to a film for improving contrast, the film capable of reducing a decrease of the contrast by shielding light from an external light source and of preventing an occurrence of moire when attached to a display apparatus, and a PDP apparatus including the film.

### BACKGROUND ART

In general, a plasma display panel (PDP) apparatus realizes a picture by exciting the fluorescent material of desired pixels by ultraviolet radiation generated by gas discharge generated between electrodes.

Due to these characteristics of the PDP apparatus, various types of electromagnetic waves and near ultraviolet rays are emitted, which are not only harmful to human body but also may be a cause of malfunction of surrounding electronic devices. Therefore, a filter is attached to a surface of the PDP apparatus to shield the electronic waves and ultraviolet rays. The filter includes one of an electromagnetic wave shielding net and a near ultraviolet ray shielding film to absorb and shield the electromagnetic waves of a near ultraviolet ray region.

Since the light emitted from a PDP should reach the viewer via the filter, the PDP filter should be transparent in general.

However, during the day or in an environment with bright light, i.e., under a bright room condition, not only the light is emitted out of the PDP apparatus via the filter but also external light from the outside may enter the display device via the PDP filter. The external light entering from the outside may be reflected at the PDP panel and overlapped with the light emitted from the PDP panel to reach the viewer. Hereinafter, the external light from the outside, which is reflected at the panel and emitted back to the outside, is called reflected light.

As described above, when the light enters the display device via the transparent PDP filter, is overlapped with the light emitted from the PDP panel, and is emitted to the outside, a contrast ratio of a picture is significantly degraded. That is, the contrast ratio represents a ratio of a brightness of the light emitted from a brightest pixel to a brightness of the light emitted from a darkest pixel, and has the following relationship when only the light emitted from the PDP panel (under a perfect dark room condition) is considered.

$$contrast ratio ( dark room condition ) = \frac{brightness of white light}{brightness of black light} \qquad Equation ( 1 )$$

However, as described above, when white light and black light each including a certain portion of the reflected light are emitted together under a bright room condition, the equation is different. That is, since the white light and the black light includes the same portion of reflected light, the brightness of the pixels expressing the white light and the black light increases in accordance with the brightness of the reflected light, which may be expressed by the following Equation 2.

$$contrast ratio ( bright room condition ) = \frac{\begin{matrix}brightness of white light + \\ brightness of reflected light\end{matrix}}{\begin{matrix}brightness of black light + \\ brightness of reflected light\end{matrix}} \qquad Equation ( 2 )$$

Since the brightness of white light is greater than the brightness of black light, the contrast ratio according to Equation 1 generally has a value greater than 1. In this case, when the brightness of the reflected light is added to the numerator and the denominator, respectively, the contrast ratio decreases. Therefore, for the same display device, a dark room contrast ratio is significantly different from a bright room contrast ratio.

The contrast ratio represents how easily the pixels are distinguished, and a higher contrast ratio indicates a clearer picture. Therefore, when other conditions are fixed, it is necessary to maintain a relatively high contrast ratio. In particular, since the bright room contrast ratio is lower than the dark room contrast ratio, it is necessary to increase the bright room contrast ratio.

Conventionally, there has been proposed a technology of using a color-correcting film to increase the contrast ratio. That is, the color-correcting film increases the contrast ratio of Equation 1 by decreasing the brightnesses of both the white light and the black light emitted from the display device. However, when the color-correcting film is used, the brightness of the light emitted from the PDP also decreases, which disadvantageously lowers the luminance of the picture.

### DISCLOSURE OF INVENTION

### Technical Problem

An aspect of the present invention provides a film capable of improving contrast ratio of a screen without decreasing a brightness of light emitted from a PDP, a PDP filter including the film, and a display apparatus, the PDP filter and the display apparatus preventing moire.

### Technical Solution

According to an aspect of the present invention, there is provided a film for improving contrast, the film included in the filter for improving contrast including a pattern of a plurality of stripes with a section in the shape of one of being narrowed from a surface to an inner portion of the film such as a trapezoid and triangle and having a uniform width such as a rectangle and a parallelogram, wherein an angle formed by the stripe pattern and a horizontal line is 0 to 5° when staring at the film in front of the same.

The film may be formed on a supporter. The supporter may be a transparent plastic film selected from a polyester resin film, an acrylic resin film, a cellulose resin film, a polyethylene resin film, a polypropylene resin film, a polyolefin resin film, a polyvinyl chloride resin film, a polycarbonate resin film, a phenolic resin film, and a urethane resin film. Particularly, the supporter may be a polyester film material.

The film may include one or more transparent film layers.

The stripe pattern may have a pitch, which is a distance between a center of a stripe and a center of another adjacent stripe, of 50 to 120μm and a depth of 70 to 200 μm .

In this case, the stripe pattern may be formed of one of a black ink, a black dye, a black pigment and an inorganic material.

The stripe pattern may occupy 50% or less of the surface of the film.

The film may be one or more ultraviolet curable resins selected from a group consisting of urethane acrylate, epoxy acrylate, ester acrylate, ether acrylate and a radical-generating monomer.

According to another aspect of the present invention, there is provided a plasma display panel filter for improving contrast, the filter on which the film for improving contrast is deposited, the filter including one or more of a transparent substrate, an anti-reflective layer, an electromagnetic wave shielding layer, and a near infrared absorption layer, wherein the film included in the filter for improving contrast includes a pattern of a plurality of stripes with a section in the shape of one of being narrowed from a surface to an inner portion of the film such as a trapezoid and triangle and having a uniform width such as a rectangle and a parallelogram, and an angle formed by the stripe pattern and a horizontal line is 0 to 5° when staring at the film in front.

A mesh of an electromagnetic wave shielding net included in the electromagnetic wave shielding layer may be disposed at an angle of 35 to 55° toward a horizontal plane.

The mesh of the electromagnetic wave shielding net may have a pitch of 100 to 500 μm .

Lines forming the electromagnetic wave shielding net may have a thickness of 5 to 35 μm .

The electromagnetic wave shielding net may be formed of a material selected from Cu, Ag, Ni, Al, Cr, Fe, and Ti, which have high conductivity.

According to still another aspect of the present invention, there is provided a plasma display panel apparatus including a plasma display panel and the filter for improving contrast, the filter attached to the plasma display panel, wherein a film included in the filter for improving contrast includes a pattern of a plurality of stripes with a section in the shape of one of being narrowed from a surface to an inner portion of the film such as a trapezoid and triangle and having a uniform width such as a rectangle and a parallelogram, wherein an angle formed by the stripe pattern and a horizontal line is 0 to 5° when staring at the film in front.

The mesh of the electromagnetic wave shielding net may have a pitch of 100 to 500 μm .

Lines forming the electromagnetic wave shielding net may have a thickness of 5 to 35 μm .

The electromagnetic wave shielding net may be formed of a material selected from Cu, Ag, Ni, Al, Cr, Fe, and Ti, which have high conductivity.

### BRIEF DESCRIPTION OF THE DRAWINGS

FIG. 1 is a perspective view illustrating a film for improving contrast;

FIG. 2 is a cross-sectional view illustrating the film to describe terms such as a light shielding angle and a pitch and depth of a stripe pattern;

FIG. 3 is a cross-sectional view illustrating the film to illustrate a theory of shielding light by using a stripe shielding pattern formed on the film;

FIG. 4 is a concept view illustrating various sorts of terms such as a pitch, width, and angle in a plasma display panel (PDP) filter and PDP pixels;

FIG. 5 is a view illustrating a size of a film for improving contrast, which is used in embodiments of the present invention; and

FIG. 6 is a schematic diagram illustrating film deposition patterns of an embodiment of the present invention and a comparative example.

### MODE FOR THE INVENTION

Hereinafter, exemplary embodiments of the present invention will now be described in detail with reference to the accompanying drawings.

A film according to the present invention decreases a brightness of the reflected light by blocking external light entering from the outside as shown in Equation 2, instead of by decreasing brightnesses of both of black light and white light to improve a contrast ratio, i.e., decreasing a brightness of an entire picture to improve the contrast ratio.

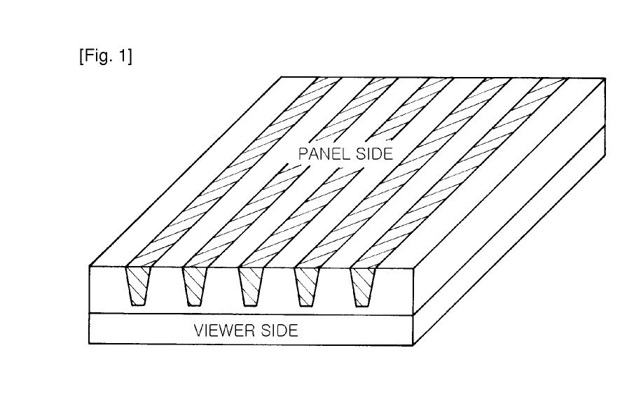

That is, as shown in FIG. 1, the film according to the present invention includes a pattern of a plurality of stripes. Each of the stripes is formed in a certain depth from a surface of the film, in a thickness direction of the film. In particular, each of the stripes may have a smaller width in a surface portion of the film than in an inner portion of the film.

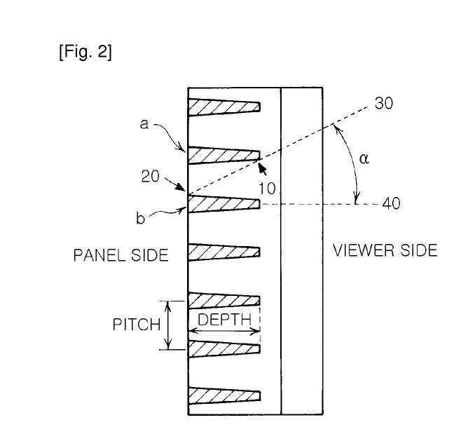

Therefore, examining a cross-section of the film shown in FIG. 2, each of the stripes may have a section in the shape of one of a trapezoid with a larger width in a surface portion of the film than in an inner portion of the film, a triangle to an extreme, and a rectangle or a parallelogram with a constant width.

The external light entering from the outside is blocked by the above-described stripes as much as possible while the light emitted out of the panel can reach the observer without being blocked. The reason for this in detail is as follows.

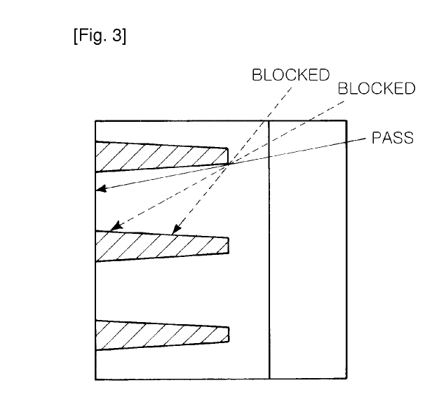

As shown in FIG. 3, when the film having a pattern of a plurality of stripes is formed at an outer side of a PDP apparatus, the stripes function as a blocking wall for blocking light. That is, the light incident into the panel via a PDP filter, at a certain angle or greater, is absorbed and blocked by the stripes. Therefore, in order for the external light to reach the panel and be reflected, it has to be incident almost perpendicularly to a surface of the film. Thus, only a very small portion of the external light may be included in the portion of light actually emitted from the display device.

In addition, having a shape narrowing toward an outer side of the display device (in a thickness direction of the film) when viewed from a side of the PDP panel, the stripes prevent the light emitted out of the panel from being blocked in its path as much as possible, thereby maintaining a sufficient brightness of the emitted light.

As a result, the brightness of the reflected light in Equation 2 may be minimized, and as a result, a contrast ratio is maximized while the brightness of the light emitted from the panel is not decreased.

The wider side of the stripe may be arranged toward the panel as described above, but the present invention is not limited thereto and either side of the film may be arranged toward the panel or the viewer.

When applying the film for improving contrast according to an exemplary embodiment of the present invention to a PDP film or a display device, a contrast ratio may be improved more than 1.5 times of when the film is not applied.

However, since the film has the stripe pattern, when applying the film to a PDP apparatus or a filter, it is worried that a moire pattern may inevitably occur.

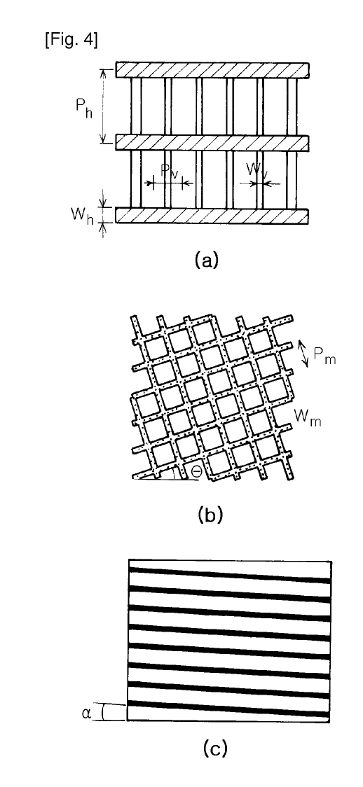

As a result of researches, the inventors of the present invention may know that a stripe pattern of a film for improving contrast may be a pixel pattern in which horizontal lines are parallel to a horizontal plane and actually orthogonal to vertical lines, as shown in FIG. 4(a) and be at an angle of 0 to 5° with respect to the horizontal plane as shown in FIG. 4(c), to prevent the moire pattern. Also, to reduce the moire with respect to the pixel pattern or the film, a mesh of an electromagnetic wave shielding layer may be disposed at an angle (θ of FIG. 4) of 35 to 55° toward a horizontal plane, as shown in FIG. 4(b), more particularly, may be 40 to 50°, and most particularly, may be 45 to 50°.

In this case, to more reduce an occurrence of the moire, pixels of a PDP apparatus may have, for example, a pitch in a horizontal direction (pₕ of FIG. 4) of about 300μm and a pitch in a vertical direction (pᵥ of FIG. 4) of about 670μm . In this case, the pitch indicates a distance between a center of a horizontal line or vertical line to a center of another adjacent horizontal line or vertical line of a lattice pattern. Also, in the PDP apparatus having such a pitch form, thicknesses (corresponding to w of FIG. 4) of the horizontal line and vertical line forming the lattice pattern are generally 55μm and 270μm , respectively.

Also, the electromagnetic wave shielding net may have a pitch (pₘ of FIG. 4) of 100 to 500μm and a thickness (wₘ of FIG. 4) of 5 to 35μm . A material forming the electromagnetic wave shielding net may be one of Cu, Ag, Ni, Al, Cr, Fe, and Ti, which have high conductivity.

Accordingly, a PDP filter according to an exemplary embodiment of the present invention includes is a PDP filter on which the film for improving contrast is deposited and includes one or more of a transparent substrate, an anti-reflective layer, an electromagnetic wave shielding layer, and a near infrared absorption layer. The stripe pattern of the film is at an angle of 0 to 5° (α of FIG. 4) with respect to a horizontal plane.

A PDP apparatus including a film for improving contrast and the PDP filter may include the described film for improving contrast, in which the film and a horizontal line of a pixel form an angle of 0 to 5° (of FIG. 4).

Next, a detailed form of the film for improving contrast to prevent the moire pattern will be described.

The stripe pattern described above may obtain the described effect by having appropriate sizes. According to a result of researches of the inventors, it is required to form a shape of the stripe pattern to allow a light shielding angle shown in FIG. 2 to be less than a certain degree. That is, the light shielding angle indicates an angle formed by a line 30 connecting an edge 10 of an inner side of one stripe of two adjacent stripes with an adjacent edge 20 of a surface side of an another stripe and a normal perpendicular to a surface of the film. Since the wider the light shielding angle, the more amount of light reflected instead of being prevented by the stripe pattern, the light shielding angle should be small to be advantageous to improve a contrast ratio. Only, when a light shielding angle is too small, a vertical viewing angle becomes too small, thereby generating a problem in visibility.

Also, as a more detailed form of the stripe pattern, a stripe pitch designating a distance between centers of two adjacent stripes may be 50 to 120μm and a depth of the stripe may be 70 to 200μm . When the pitch is too wide, that is, a depth of the stripe is too great, a thickness of a film increases and the stripe pattern may be seen by a viewer. When the pitch is too small, that is, a depth of the stripe is too small, the stripe pattern is required to be very accurately formed, thereby causing an excessive workload.

Also, the stripe pattern may occupy 50% or less portion of the surface of the film. When the occupied portion is more than 50%, light emitted from a display apparatus is excessively shielded, thereby reducing brightness. Also, it is not required to particularly determine a lower limit of a rate of the occupied portion since it is ad vantageous the occupied portion is as small as possible when the described light shielding effect is sufficient. Merely, when employing the light shielding angle and the stripe pattern according to an exemplary embodiment of the present invention, the stripe pattern should be minutely formed when the rate of the occupied portion is too small. Accordingly, it is general to determine the rate of the occupied portion of the stripe pattern to be 5% or more.

When employing the described stripe pattern, since external light incident into a PDP is reduced but light emitted from the inside is not shielded, a contrast ratio may be improved within a range of maintaining a brightness of the display apparatus.

Accordingly, each of the stripes may have a section in the shape of one of a trapezoid with a larger width in a surface portion of the film than in an inner portion of the film, a triangle to an extreme, and a rectangle or a parallelogram with a constant width. Also, in a cross-sectional view cut along a thickness direction of the film for improving contrast, an angle formed by a line connecting an edge 10 of an inner side of one stripe of two adjacent stripes with an adjacent edge 20 of a surface side of an another stripe and a normal perpendicular to a surface of the film may be 15 to 50°, and particularly, 20 to 35°.

To provide the light shielding characteristics of the film for improving contrast as possible and to easily discharge light emitted from the inside, as shown in FIG. 2, a material forming the film including the stripe pattern may be a transparent ultraviolet curable resin, and more particularly, may be one or more photocurable resin material selected from a group consisting of urethane acrylate, epoxy acrylate, ester acrylate, ether acrylate and a radical-generating monomer. The material may be formed alone. However, as shown in FIG. 2, the material may be formed above a supporter that is a transparent plastic film formed of a material such as a polyester resin film, an acrylic resin film, a cellulose resin film, a polyethylene resin film, a polypropylene resin film, a polyolefin resin film, a polyvinyl chloride resin film, a polycarbonate resin film, a phenolic resin film, and a urethane resin film. More particularly, the material may be formed above a supporter formed of a polyester film material. In addition, the film for improving contrast may further one or more transparent film layers when necessary.

Also, the stripe pattern of the film may be formed by forming a mold using a bite, forming a stripe shape using an ultraviolet curable resin, and filling the shape with a black resin. The material of the stripes may have a light absorption ratio α which is shown as Equation 3, may be 10/mm or more, and more particularly, 40/mm or more. When the rate of light absorption is less than 10/mm, it is disadvantageous since a light shielding effect is insufficient. The material for the stripe pattern having such a light shielding rate may be one of a black ink, a black dye, a black pigment and an inorganic material.

$$α = - \frac{ln ( I / {I}_{o} )}{L} \qquad Equation ( 3 )$$

where I₀ indicates an intensity of light, particularly, a visible light, before passing through the material for the stripe pattern, I indicates an intensity of light after passing through the material for the stripe pattern, and L indicates a thickness of the material for the stripe pattern.

### EXAMPLE

### Stripe Pattern Formation

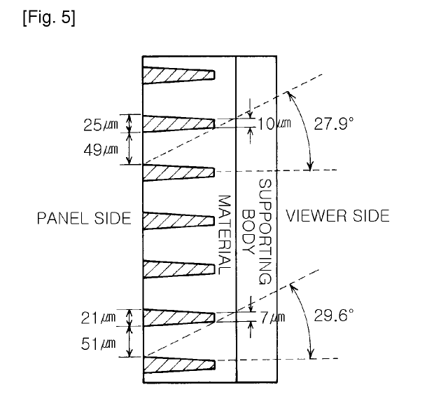

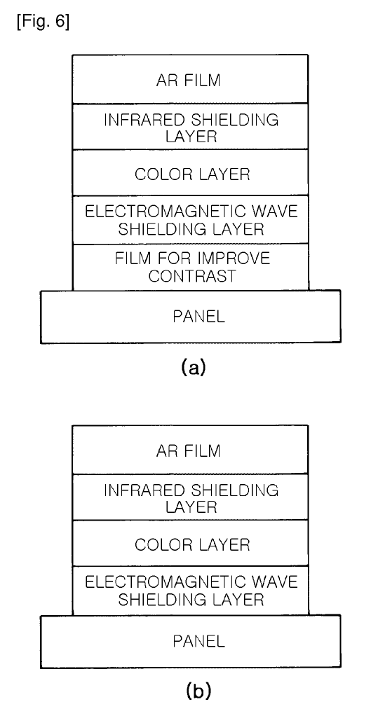

The films for improving contrast for inventive samples 1 and 2 were fabricated under the conditions illustrated in FIG. 5. Each of the films was deposited at 2.5 with respect to a horizontal plane of the filter as shown in FIG. 6(a) and attached directly to a PDP panel and the change in the contrast ratio was observed. In this case, area ratios of the stripes to surfaces of the films were set to be 33.8% and 29.2% for the inventive samples 1 and 2, respectively. The stripes were formed in a urethane light-curable resin, and the stripes were formed of black ink. In addition, the supporter illustrated in FIG. 5 was formed of a polyester film. The shielding net of the electromagnetic wave shielding layer was disposed at an angle of 41° with respect to the horizontal plane of the PDP panel.

For comparison, a PDP apparatus without the film for improving contrast was manufactured as shown in FIG. 6(b) for a comparative sample.

The inventive samples 1 and 2, employing the film for improving contrast, and the comparative sample, without the film for improving contrast, were adjusted to have the substantially same transmittance in layer thereof except the panel, and results were compared.

For each of the inventive samples 1 and 2 and the comparative sample, a transmittance, a luminance at black level, a luminance at white level and a contrast ratio were measured as shown in Table 1. The luminance and transparency were measured by PR705 Spectroradiometer, while varying the luminous intensity at 150 lx, 300 lx and 400 lx.

TABLE 1

| | | Inventive | Inventive | Comparative |
|---|---|---|---|---|
| Sample | | sample 1 | Sample 2 | Sample |
| Transmittance (%) | | 42.4 | 44 | 41.8 |
| black level (Cd/m²) | 150 1x | 1.72 | 2.08 | 3.27 |
| | 300 1x | 3.05 | 3.72 | 6.02 |
| | 400 1x | 3.65 | 4.52 | 7.50 |
| white level (Cd/m²) | 150 1x | 97.87 | 106 | 103 |
| | 300 1x | 99.03 | 107 | 105.1 |
| | 400 1x | 100.1 | 108.4 | 106.9 |
| contrast ratio | 150 1x | 57.0 (81% | 51.0 (62% | 31.5 |
| | | increase) | increase) | |
| | 300 1x | 32.5 (86% | 28.7 (64% | 17.5 |
| | | increase) | increase) | |
| | 400 1x | 27.4 (93% | 24.0 (69% | 14.2 |
| | | increase) | increase) | |

As confirmed in Table 1, the inventive samples 1 and 2 and the comparative sample exhibited transmittances of 42.4, 44 and 41.8%, respectively, at a similar level. However, the inventive sample 1 exhibited a contrast ratio of 27.4:1 to 57.0:1, and the inventive sample 2 exhibited a contrast ratio of 24.0:1 to 51.0:1, whereas the comparative sample exhibited a contrast ratio of 14.2:1 to 31.5:1, which is much lower than the inventive samples. Therefore, the contrast-improving effect of the film for improving contrast according to the present invention was confirmed.

Preventive Effect of Moire

The PDP filter including the film for improving contrast having the advantageous effect as described herein (under the same conditions as inventive sample 1) was attached to a PDP panel to examine the preventive effect of moire. In the panel used in the experiment, the pixel had a horizontal pitch of 300μm , a vertical pitch of 670μm , a horizontal line thickness of 270μm , and a vertical line thickness of 55 μm .

For convenience of experimentation, an electromagnetic wave shielding layer, having an electromagnetic wave shielding net formed of a copper material having a pitch of 200μm and a line thickness of 20μm , was attached to an upper part of the PDP panel, disposed at 41 with respect to a horizontal plane of the panel. While varying the angle of disposition of the stripes of the film for improving contrast with respect to the horizontal lines of the panel, the moire phenomenon was observed. The results are shown in Table 2, in which ◯ denotes no moire observed, Δ denotes a mild degree of moire observed, and x denotes a severe degree of moire observed, potentially affecting the picture quality.

TABLE 2

angle (°)

| | 1.5 | 2.5 | 4 | 6 | 10 | 14 | 18 | 21 |
|---|---|---|---|---|---|---|---|---|
| moire | ◯ | ◯ | ◯ | Δ | Δ | Δ | X | X |

As shown in the results of Table 2, when the angle formed between the stripes of the film for improving contrast and the horizontal lines of the panel was 5 or less, moire was not observed at all, whereas when the angle was 5 to 14° a mild degree of moire was observed, and when the angle was 15 or more, a severe degree of moire was observed. Therefore, the stripes of the film for improving contrast may be disposed at an angle of 0 to 15° and particularly, at an angle of 0 to 5° with respect to the horizontal lines of the panel.

Also, after forming a stripe pattern with a condition identical to the inventive sample 1 in addition to setting an angle with respect to the stripe pattern to be 3.7° to check an effect of an angle formed by horizontal lines of an electromagnetic shielding net and a horizontal plane, it is observed whether a moire pattern is formed, by varying an angle formed by the electromagnetic shielding net and a horizontal plane of a PDP panel such as a PDP 50 inches XGA-level module from 0 to 90° by one degree.

TABLE 3

| | Angle of electromagneticshielding | | | | |
|---|---|---|---|---|---|
| | net (°) | | | | |
| | 0~34 | 35~39 | 40~50 | 51~55 | 56~90 |
| Whether moire forms | X | Δ | ◯ | Δ | X |

As confirmed in Table 3, when the angle formed by the electromagnetic shielding net and the horizontal plane is less than 35° or more than 55°, a severe degree of moire is observed. When the angle is within a range of one of 35° or more, less than 39°, and more than 50° and 55° or less, a mild degree of moire is formed. When the angle is within a range of 40 to 50°, moire was not observed at all.

Accordingly, an appropriate angel with respect to the horizontal plane of the electromagnetic shielding net may be 35 to 55°. More particularly, the angle may be 40 to 50°. Most particularly, the angle may be 45 to 50°. In this case, though the cases of 45 to 50° and 45 to 50° are classified to be identical according to a classification basis, it may be checked by the naked eye that the case of 45 to 500 is more preferable.

Therefore, the advantageous effect of the present invention may be confirmed.

### INDUSTRIAL APPLICABILITY

According to an aspect of the present invention, there are provided a film capable of improving contrast ratio of a screen without decreasing a brightness of light emitted from a PDP, a PDP filter including the film, and a display apparatus. The provided PDP filter and the display apparatus provide a screen having a high quality preventing moire.

1. A film for improving contrast, the film comprising a pattern of a plurality of stripes with a section in the shape of one of being narrowed from a surface to an inner portion of the film such as a trapezoid and triangle and having a uniform width such as a rectangle and a parallelogram,
wherein an angle formed by the stripe pattern and a horizontal line is 0 to 5° when staring at the film in front.

2. The film of claim 1, wherein the film is formed on a supporter.

3. The film of claim 2, wherein the supporter is a transparent plastic film selected from a polyester resin film, an acrylic resin film, a cellulose resin film, a polyethylene resin film, a polypropylene resin film, a polyolefin resin film, a polyvinyl chloride resin film, a polycarbonate resin film, a phenolic resin film, and a urethane resin film.

4. The film of claim 3, wherein the supporter is a polyester film material.

5. The film of claim 1, further comprising one or more transparent film layers.

6. the film of claim 1, the stripe pattern has a pitch, which is a distance between a center of a stripe and a center of another adjacent stripe, of 50 to 120 pₘ and a depth of 70 to 200 pₘ.

7. The film of claim 1, wherein the stripe pattern is formed of a material of a black ink, a black dye, a black pigment and an inorganic material.

8. The film of claim 1, wherein the stripe pattern occupies 50% or less of the surface of the film.

9. The film of claim 1, wherein the film is one or more ultraviolet curable resins selected from a group consisting of urethane acrylate, epoxy acrylate, ester acrylate, ether acrylate and a radical-generating monomer.

10. A plasma display panel filter for improving contrast, the filter on which the film for improving contrast according to claim 1 is deposited, the filter comprising one or more of a transparent substrate, an anti-reflective layer, an electromagnetic wave shielding layer, and a near infrared absorption layer,
wherein the film included in the filter for improving contrast comprises a pattern of a plurality of stripes with a section in the shape of one of being narrowed from a surface to an inner portion of the film such as a trapezoid and triangle and having a uniform width such as a rectangle and a parallelogram, and
an angle formed by the stripe pattern and a horizontal line of 0 to 5° when staring at the film in front of the same.

11. The filter of claim 10, wherein an electromagnetic wave shielding net included in the electromagnetic wave shielding layer has a horizontal line disposed at an angle of 35 to 55° toward a horizontal plane.

12. The filter of claim 10, wherein a pitch, which is a distance between centerlines of two horizontal lines or two vertical lines, those adjacent to each other and forming the electromagnetic wave shielding net, is 100 to 500 μm.

13. The filter of claim 10, lines forming the electromagnetic wave shielding net has a thickness of 5 to 35 μm.

14. The filter of claim 10, wherein the electromagnetic wave shielding net is formed of a material selected from Cu, Ag, Ni, Al, Cr, Fe, and Ti.

15. A plasma display panel apparatus comprising a plasma display panel and the filter for improving contrast according to claim 10, the filter attached to the plasma display panel,
wherein a film included in the filter for improving contrast comprises a pattern of a plurality of stripes with a section in the shape of one of being narrowed from a surface to an inner portion of the film such as a trapezoid and triangle and having a uniform width such as a rectangle and a parallelogram,
wherein an angle formed by the stripe pattern and a horizontal line is 0 to 50 when staring at the film in front of the same.

16. The apparatus of claim 15, wherein a pitch, which is a distance between centerlines of two horizontal lines or two vertical lines, those adjacent to each other and forming the electromagnetic wave shielding net, is 100 to 500 μm.

17. The apparatus of claim 15, lines forming the electromagnetic wave shielding net has a thickness of 5 to 35 μm.

18. The apparatus of claim 15, wherein the electromagnetic wave shielding net is formed of a material selected from Cu, Ag, Ni, Al, Cr, Fe, and Ti.
